(19) United States
(12) Patent Application Publication
(10) Pub. No.: US 2025/0215537 A1
(43) Pub. Date: Jul. 3, 2025

(54) Composite for Switchgears

(71) Applicant: ABB Schweiz AG, Baden (CH)

(72) Inventors: Anish Paul, Brugg (CH); Christoph Kenel, Baden (CH); Markus Hoidis, Niederrohrdorf (CH); Cornelia Lang, Hausen AG (CH); Jean-Marc Oppliger, Fislisbach (CH)

(73) Assignee: ABB Schweiz AG, Baden (CH)

(21) Appl. No.: 18/986,913

(22) Filed: Dec. 19, 2024

(30) Foreign Application Priority Data
Dec. 28, 2023 (EP) 23220454.5

(51) Int. Cl. C22C 32/00; B22F 3/15; C22C 1/04; C22C 1/051

(52) U.S. Cl. CPC C22C 32/0052; C22C 1/0466; C22C 1/051; B22F 3/15; B22F 2301/255; B22F 2302/10; B22F 2998/10

(57) ABSTRACT

Composite including hafnium carbide (HfC) and/or zirconium carbide (ZrC) and process for the production thereof.

### CROSS-REFERENCE TO RELATED APPLICATIONS

The instant application claims priority to European Patent Application No. 23220454.5, filed Dec. 28, 2023, which is incorporated herein in its entirety by reference.

### FIELD OF THE DISCLOSURE

The present disclosure generally relates to materials suitable for low voltage switchgears.

### BACKGROUND OF THE INVENTION

Silver (Ag) based materials currently used in low voltage switchgears are composites of silver with graphite (Ag/C), tungsten, W (Ag/W) or tungsten carbide, WC (Ag/WC) for providing properties such as arc erosion resistance and welding resistance. During an arcing event, these materials are exposed to high temperature causing undesirable physical, chemical and/or compositional changes. In the case of Ag/W and Ag/WC, W and WC oxidize to form WO₃. WO₃ is a strongly adherent oxide with low electrical conductivity.

WO₃ has a melting point of 1473° C. and a boiling point of 1700° C. Since the temperature generated during arcing is well above this, it leads to evaporation of the oxidation products leading to compositional changes near the contact faces. This ultimately, adversely affects the performance. A part of the oxide that has not seen its boiling temperature, remains strongly adhered to the contact surface. This increases the contact resistance increasing electrical losses during operation of the product.

In addition to the formation of pure oxides, it is also known that tungsten (W) and tungsten carbide (WC) form an electrically non-conducting, combined oxide with Ag (silver tungstate, Ag₂WO₄). The melting point of silver tungstate is very low (580-620° C.) compared to the oxides and carbides. The formation of such tungstates further accelerates the material loss and changes the electrical properties. This can detrimentally affect the performance of the devices where such materials are used. Generally speaking, there is a need for a material providing a good balance of welding properties especially of closed contacts and during make operations, low erosion by arcing, low arc dwell time, low contact resistance after arcing and high arc re-ignition voltage.

### BRIEF SUMMARY OF THE INVENTION

The present disclosure is based on the finding that a composite including hafnium carbide (HfC) and/or zirconium carbide (ZrC) allows to address those needs.

The present invention provides a composite including hafnium carbide (HfC) and/or zirconium carbide (ZrC) having
a) a total carbide content being the sum of tungsten containing carbides, hafnium carbide, zirconium carbide, tantalum carbide and chromium carbide of more than 30 wt.-% with respect to the total weight of the composite, and
b) a combined amount of hafnium carbide and/or zirconium carbide of 0.1 wt.-% to 40 wt.-% with respect to the total carbide content, and
c) optionally up to 4.0 wt.-% of a metal component selected from the group of elements consisting of Ni, Co, Cu, Fe, Cr, Mo and mixtures thereof with respect to the total weight of the composite, and
d) optionally up to 18.0 wt.-% of nickel (Ni) or of further nickel with respect to the total weight of the composite, and
e) the balance being silver (Ag) and unavoidable impurities.

The present disclosure further provides a composite as described herein obtainable by:
a) providing
   aa) hafnium carbide powder (HfC) and/or zirconium carbide powder (ZrC),
   bb) silver powder (Ag),
   cc) optionally tungsten carbide powder (WC),
   dd) optionally a metal component selected from the group of elements consisting of Ni, Co, Cu, Fe, Cr, Mo and mixtures thereof in powder form,
   ee) optionally nickel (Ni) or further nickel;
b) mixing all powders as provided in step a) thereby yielding a premix,
c) optionally sieving the premix and obtaining a sieved premix,
d) compacting the premix or the sieved premix to form a green body,
e) subjecting the green body to sintering, whereby
   the sintering is liquid phase sintering (LPS) within a temperature range of 960 to 1300° C., preferably 960 to 1150° C. under hydrogen atmosphere;
f) optionally subjecting the sintered premix or sintered sieved premix to repressing and/or hot isotactic pressing (HIP).

The present invention also provides
a process for providing a composite including hafnium carbide (HfC) and/or zirconium carbide (ZrC) having
a) a total carbide content being the sum of tungsten containing carbides, hafnium carbide, zirconium carbide, tantalum carbide and chromium carbide of more than 30 wt.-% with respect to the total weight of the composite, and
b) a combined amount of hafnium carbide and/or zirconium carbide of 0.1 wt.-% to 40 wt.-% with respect to the total carbide content, and
c) optionally up to 4.0 wt.-% of a metal component selected from the group of elements consisting of Ni, Co, Cu, Fe, Cr, Mo and mixtures thereof with respect to the total weight of the composite, and
d) optionally up to 18.0 wt.-% of nickel (Ni) or further nickel with respect to the total weight of the composite, and
e) the balance being silver (Ag) and unavoidable impurities,
the process comprising the steps of
i) providing
   aa) hafnium carbide powder (HfC) and/or zirconium carbide powder (ZrC),
   bb) optionally silver powder (Ag),
   cc) optionally tungsten carbide powder (WC),
   dd) optionally a metal component selected from the group of elements consisting of Ni, Co, Cu, Fe, Cr, Mo and mixtures thereof in powder form,
   ee) optionally up to 18 wt.-% of nickel (Ni) or further nickel with respect to the total weight of the composite,
ii) mixing all powders as provided in step i) thereby yielding a premix,
iii) optionally sieving the premix and obtaining a sieved premix,
iv) compacting the premix or the sieved premix to form a green body,
v) combined sintering and silver infiltrating the green body within a temperature range of 960 to 1300° C., preferably 960 to 1150° C., and
vi) optionally repressing and/or hot isostatic pressing (HIP).

In a further aspect the present invention describes a switchgear comprising the composite as described herein. In yet another aspect, the present invention is concerned with the use of a composite as described herein for switchgear, preferably low voltage switchgear.

### DETAILED DESCRIPTION OF THE INVENTION

A first particularly preferred embodiment is a composite including hafnium carbide (HfC) and/or zirconium carbide (ZrC), the composite having a total carbide content being the sum of tungsten containing carbides, hafnium carbide, zirconium carbide, tantalum carbide and chromium carbide of 38.0 to 45.0 wt.-% with respect to the total weight of the composite, and a combined amount of hafnium carbide and/or zirconium carbide of 4.0 wt.-% to 20.0 wt.-% with respect to the total carbide content, and 0.5 to 1.5 wt.-% of a metal component selected from the group of elements consisting of Ni, Co, Cu, Fe, Cr, Mo and mixtures thereof with respect to the total weight of the composite, the preferred metal component being Ni only, and the balance being silver (Ag) and unavoidable impurities. It is preferred that no zirconium carbide is present in this embodiment.

A second particularly preferred embodiment is a composite including hafnium carbide (HfC) and/or zirconium carbide (ZrC), the composite having a total carbide content being the sum of tungsten containing carbides, hafnium carbide, zirconium carbide, tantalum carbide and chromium carbide of 38.0 to 45.0 wt.-% with respect to the total weight of the composite, and a combined amount of hafnium carbide and/or zirconium carbide of 4.0 wt.-% to 20.0 wt.-% with respect to the total carbide content, and up to 4.0 wt.-% of a metal component selected from the group of elements consisting of Co, Cu, Fe, Cr, Mo and mixtures thereof with respect to the total weight of the composite, and nickel (Ni) in a total of amount of 4.0 to 20 w.-% with respect to the total weight of the composite, the balance being silver (Ag) and unavoidable impurities. It is preferred that no zirconium carbide is present in this embodiment.

A third particularly preferred embodiment is a composite including hafnium carbide (HfC) and/or zirconium carbide (ZrC), the composite having a total carbide content being the sum of tungsten containing carbides, hafnium carbide, zirconium carbide, tantalum carbide and chromium carbide of above 45.0 to 55.0 wt.-% with respect to the total weight of the composite, and a combined amount of hafnium carbide and/or zirconium carbide of 3.0 wt.-% to 25.0 wt.-% with respect to the total carbide content, and 0.5 to 1.5 wt.-% of a metal component selected from the group of elements consisting of Ni, Co, Cu, Fe, Cr, Mo and mixtures thereof with respect to the total weight of the composite, the preferred metal component being Ni only, and the balance being silver (Ag) and unavoidable impurities. It is preferred that no zirconium carbide is present in this embodiment.

A 4th particularly preferred embodiment is a composite including hafnium carbide (HfC) and/or zirconium carbide (ZrC), the composite having a total carbide content being the sum of tungsten containing carbides, hafnium carbide, zirconium carbide, tantalum carbide and chromium carbide of above 45.0 to 55.0 wt.-% with respect to the total weight of the composite, and a combined amount of hafnium carbide and/or zirconium carbide of 3.0 wt.-% to 25.0 wt.-% with respect to the total carbide content, and up to 4.0 wt.-% of a metal component selected from the group of elements consisting of Co, Cu, Fe, Cr, Mo and mixtures thereof with respect to the total weight of the composite, the preferred metal component being Ni only, and nickel (Ni) in a total of amount of 4.0 to 20 w.-% with respect to the total weight of the composite, and the balance being silver (Ag) and unavoidable impurities. It is preferred that no zirconium carbide is present in this embodiment.

These particularly preferred embodiments can be combined with any aspect as described above as far as appropriate.

Experimental Part. Starting Materials—Commercially available starting materials were used: Ag (d50<5 μm); WC (d50<3 μm); Ni (d50<5 μm); HfC (d50<4 μm).

General Process: Reference specimens were prepared using Ag and WC but without the addition of HfC. Some samples were prepared without the addition of any nickel. The majority of test samples included the addition of nickel. The powder constituents for different formulations were weighed in the desired ratio.

Powder mixing was performed for 64 hours using a Turbula® mixer employing ZrO2 milling media. After mixing, the powder was sieved using 100 μm sieve to remove large agglomerates. Green bodies were prepared by die pressing at 300 MPa. 8 mm diameter samples were prepared for sintering investigations and 26 mm diameter samples were prepared for property measurements.

Sintering of the green bodies was performed using the hydrogen furnace under H₂ gas atmosphere. Solid state sintering (SSS), liquid phase sintering (LPS) and liquid phase sintering with Ag infiltration (LPS+I) were investigated. Sintering temperature ranged from 950 up to 1300° C. Most of the sintering trials were conducted at 20 mbar pressure inside the furnace with a few trials performed at 900 mbar pressure as indicated below. For additional evaluation, the Ni content was varied from 1 wt. % to 2 wt. % and 5 wt. % for certain samples.

Measurement methods: Density—The density of the green bodies was measured using geometrical methods. Sintered density was measured using the Archimedes technique with ethanol as the displacing medium.

Microstructure—Microstructure of the specimens were evaluated according to standard metallographic preparation techniques. Optical microscopy was performed on several samples whilst selected samples were analyzed using scanning electron microscopy (SEM) and energy dispersive spectroscopy (EDS) to evaluate the microstructure and the distribution of elements.

Vickers hardness (HV1) of selected composites were measured on polished cross-sections. At least 10 measurements were performed on each specimen.

Electrical conductivity was measured on 26 mm diameter flat specimens. 3 measurements each were performed on the top and bottom surface of each specimen (total 6 measurements on each specimen).

Evaluation of wetting by variation of Ni content—In a first experimental series, Ag64.8HfC34.2Ni1, Ag63.8HfC34.2Ni2, and Ag60.8HfC34.2Ni5 were evaluated. Ag65.8HfC34.2 was used for comparative purposes. Sintering trials were performed at 1100° C., 1200° C. and 1300° C. The sintering experiments were made at 20 mbar under hydrogen. Both, liquid phase sintering and liquid phase sintering plus silver infiltration were evaluated. Cross-sectional analysis of the specimens indicated the formation of cracks for comparative Ag65.8HfC34.2 and Ag60.8HfC34.2Ni5. It turned out that a maximum of 2 wt.-% nickel, is perfectly acceptable and beneficial in terms of process options.

Evaluation of silver mass loss vis-à-vis sintering temperature—Sintering plus silver infiltration using silver foils was evaluated (temperatures 1000, 1050, 1100, 1200, 1300° C.; pressure all at 20 mbar hydrogen). It turned out that silver loss was acceptable up to 1200° C., whereas excessive silver loss occurred at 1300° C. It further could be shown that silver losses were lower at 900 mbar hydrogen.

Experiment runs A—For all formulations of experiment runs A, the total carbide content was chosen as 34.2 wt. %. The HfC content varied from 5% up to 100% as a percentage of the total carbide. The Ni content was kept constant at 1 wt. % and the compositions investigated are listed in Table 1 below. Table 1 also shows the green density variation. It can be seen that the green density was >70% of the theoretical density for all the compositions except for AgWC17.1HfC17.1Ni1 (50). Sintering was carried out at 1000° C. for 30 minutes at 20 mbar hydrogen. Several runs were subjected to sintering at 1050° C. for 30 min at 20 mbar hydrogen and some to sintering at 1100° C. and 1200° C. for 30 min at 20 mbar hydrogen.

Experimental Runs A
total carbide content
((WC + HfC) as wt.-% of the total composite)
34.2.0 wt.-% for all runs

| | | HfC | | | | |
|---|---|---|---|---|---|---|
| | | content | | | | |
| | | (as a % | | | | |
| | | of | green | | | |
| | Composite | total | density | density | density | density |
| | (initial formulation) | carbides) | (%) | (%)** | (%)*** | (%)**** |
| A1 | AgWC32.5HfC1.7Ni1(5)* | 5 | 72.5 | 95.2 | 95.7 | 96.5 |
| A2 | AgWC30.8HfC3.4Ni1(10)* | 10 | 73.1 | 96.1 | 96.2 | 96.5 |
| A3 | AgWC29.1HfC5.1Ni1(15)* | 15 | 71.7 | 94.6 | | 91.9 |
| A4 | AgWC27.4HfC6.8Ni1(20)* | 20 | 70.7 | 92.7 | | 94.1 |
| A5 | AgWC25.7HfC8.5Ni1(25)* | 25 | 71.8 | 91.6 | 92.7 | 92.9 |
| A6 | AgWC17.1HfC17.1Ni1(50)* | 50 | 66.4 | 79.8 | 75.3 | |
| A7 | AgWC8.5HfC25.7Ni1(75)* | 75 | 70.2 | 87.5 | 87.3 | |
| A8 | AgHfxxCNi1(100)* | 100 | 74.1 | — | | |

*the number in parenthesis (such as 5, 10 . . . 100) indicates the HfC content as the percentage of the total carbides.
**Archimedes density after sintering at 1000° C. for 30 minutes at 20 mbar hydrogen.
***Archimedes density after sintering at 1050° C. for 30 min at 20 mbar hydrogen
****Archimedes density after sintering at 1100° C. for 30 min at 20 mbar hydrogen

The sintering temperatures were further amended to 1150 and 1200° C. in additional experiments. Similar results were obtained. Silver de-wetting issues were observed with HfC contents of 50 and 75 wt.-% HfC (as to the total weight of the carbides). A uniform microstructure was observed for all the samples.

Experiment runs B—For all formulations of experiment runs B, the total carbide content was chosen as 40.0 wt. %. Due to the observed silver de-wetting (in runs A), compositions with 50 and 75 wt.-% HfC (as to the total weight of the carbides) were not evaluated.

Experimental Runs B - total carbide content ((WC +
HfC) as wt.-% of the total composite) 40.0 wt.-% for all runs

| | | HfC | | | | |
|---|---|---|---|---|---|---|
| | | content | | | | |
| | | (as a % | | | | |
| | | of | green | | | |
| | Composite | total | density | density | density | density |
| | (initial formulation) | carbides) | (%) | (%)** | (%)*** | (%)**** |
| B0 | AgWCxxNi1(0)* | 0 | 69.5 | 90.7 | 94.7 | 97.0 |
| B1 | AgWC39.6HfC0.4Ni1(1)* | 1 | 69.8 | 91.7 | 94.9 | 95.2 |
| B2 | AgWC39.2HfC0.8Ni1(2)* | 2 | 70.0 | 93.0 | — | |
| B3 | AgWC38HfC2Ni1(5)* | 5 | 68.9 | 96.8 | 97.2 | 96.3 |
| B4 | AgWC36HfC4Ni1(10)* | 10 | 68.7 | 96.0 | 96.7 | 95.9 |
| B5 | AgWC34HfC6Ni1(15)* | 15 | 68.9 | 94.9 | 95.9 | 96.0 |
| B6 | AgWC32HfC8Ni1(20)* | 20 | 69.3 | 94.2 | 95.0 | 95.0 |
| B7 | AgWC30HfC10Ni1(25)* | 25 | 69.8 | 92.5 | 93.9 | |

*the number in parenthesis (such as 0, 1, 2, 5 . . . 25) indicates the HfC content as the percentage of the total carbides.
**Archimedes density after sintering at 1000° C. for 30 minutes at 20 mbar hydrogen.
***Archimedes density after sintering at 1100° C. for 30 minutes at 20 mbar hydrogen.
****Archimedes density after sintering at 1150° C. for 30 minutes at 20 mbar hydrogen.

The presence of a metallic layer on the surface was observed for specimens when the HfC content (as a % of total carbides) was 25% indicating Ag de-wetting. No de-wetting was observed for any of the other specimens. The specimen with 2% HfC content (as a % of total carbides) showed the formation of several nodules (rough spots) on its surface.

After sintering at 1100° C. silver de-wetting was observed when the HfC content (as a % of total carbides) was 20% or higher. Similar results were obtained by sintering at 1150° C.

Additional experiments were carried out with sintering at 1200° C. Again, no silver de-wetting was observed for the specimen containing 20 wt.-% HfC (as percent of total carbides). The trend to lower density was confirmed.

It can be concluded that a sintering temperature of around 1100° C. yield highest density.

The microstructure appeared uniform for all the samples. Localized Ag de-wetting was observed for the compositions with 20% and 25% HfC content (as a % of total carbides).

Experiment runs C—For all formulations of experiment runs C, the total carbide content was chosen as 50.0 wt. %.

Experimental Runs C - total carbide content ((WC +
HfC) as wt.-% of the total composite) 50.0 wt.-% for all runs

| | | HfC | | | | |
|---|---|---|---|---|---|---|
| | | content | | | | |
| | | (as a % | | | | |
| | | of | green | | | |
| | Composite | total | density | density | density | density |
| | (initial formulation) | carbides) | (%) | (%)** | (%)*** | (%)**** |
| C1 | AgWC47.5HfC2.5Ni1(5) | 5 | 66.4 | 96.6 | 97.0 | 96.7 |
| C2 | AgWC45HfC5Ni1(10) | 10 | 67.1 | 95.5 | 96.3 | 91.6 |
| C3 | AgWC42.5HfC7.5Ni1(15) | 15 | 67.0 | 93.5 | 95.1 | 93.7 |
| C4 | AgWC40HfC10Ni1(20) | 20 | 66.8 | 91.4 | 93.5 | 95.3 |
| C5 | AgWC37.5HfC12.5Ni1(25) | 25 | 66.7 | 89.7 | 91.5 | 96.2 |

*the number in parenthesis (such as 5, 10, . . . 100) indicates the HfC content as the percentage of the total carbides.
**Archimedes density after sintering at 1000° C. for 30 minutes at 20 mbar hydrogen.
***Archimedes density after sintering at 1100° C. for 30 minutes at 20 mbar hydrogen.
****Archimedes density after sintering at 1150° C. for 30 minutes at 20 mbar hydrogen.

No de-wetting was observed for any of the other specimens. Additional experiments were carried out with sintering at 1200° C. The trends could be confirmed. The microstructure appeared uniform for all the samples.

Representative samples of the runs A1 to C5 were also evaluated using SEM/EDS to further verify the uniformity of microstructure and distribution of the constituents of the composite.

### Hardness Evaluation

| | Carbide | Sintering | |
|---|---|---|---|
| | content/ | temperature/ | Hardness |
| Experiment | wt.- % | ° C. | (HV1) |
| Run A | 34.2 | 1000 | 113 |
| | 34.2 | 1100 | 113 |
| | 34.2 | 1150 | 116 |
| | 34.2 | 1200 | 114 |
| Run B | 40.0 | 1000 | 137 |
| | 40.0 | 1100 | 137 |
| | 40.0 | 1150 | 139 |
| | 40.0 | 1200 | 135 |
| Run C | 50.0 | 1000 | 181 |
| | 50.0 | 1100 | 180 |
| | 50.0 | 1150 | 177 |
| | 50.0 | 1200 | 171 |

The hardness of the composites with 34.2 wt. % total carbide content was very low (112-114 HV1, average) irrespective of the sintering temperature. The hardness of the composites with 40 wt. % total carbide content was higher (134-140 HV1, average).

The highest hardness (170-180 HV1, average) was obtained for the specimens with 50 wt. % total carbide content. The composites with 50 wt.-% total carbide content showed much higher hardness values than that of broadly used AgWC 60/40 specimens. In summary, the final hardness is influenced by the total carbide content and the sintering temperature.

In yet a further experimental series, the influence of the HfC content (as percent of total carbide) was evaluated. The HfC content turned out to have essentially no influence as to the final hardness for the composites with 34.2 or 40 wt. % total carbides. In the composite with 50 wt. % carbide a higher HfC content (as a % of total carbides) resulted in moderately lower hardness.

### Conductivity Evaluation:

| | Carbide | Sintering | |
|---|---|---|---|
| | content/ | temperature/ | Conductivity |
| Experiment | wt.- % | ° C. | (% IACS,) |
| Run A | 34.2 | 1000 | 51.1 |
| | 34.2 | 1100 | 54.2 |
| | 34.2 | 1150 | 54.4 |
| | 34.2 | 1200 | 55.5 |
| Run B | 40.0 | 1000 | 46.1 |
| | 40.0 | 1100 | 46.3 |
| | 40.0 | 1150 | 46.8 |
| | 40.0 | 1200 | 47.1 |
| Run C | 50.0 | 1000 | 34.9 |
| | 50.0 | 1100 | 38.1 |
| | 50.0 | 1150 | 38.4 |
| | 50.0 | 1200 | 39.2 |

Oxidation Evaluation: The oxidation behavior of AgWC34HfC6Ni1 (Run B, example B6) was evaluated in an atmospheric furnace at 600° C. over 12 hours. Ag59WC40Ni1 and Ag60WC40 were used as reference materials.

| Experiment | 1 h@600° C. | 6 h@600° C. | 12 h@600 ° C. |
|---|---|---|---|
| comparative | +− | − | −− |
| Ag60WC40 | | | |
| comparative | +− | − | −− |
| Ag59WC40Ni1 | | | |
| inventive | ++ | ++ | ++ |
| AgWC34HfC6Ni1 | | | |
| (Run B, example | | | |
| B6) | | | |

Surprisingly, oxidation improvement was observed vis-à-vis the comparative materials.

While the invention has been illustrated and described in detail in the forgoing description, such description is to be considered exemplary and not restrictive. The invention is not limited to the disclosed embodiments. In view of the foregoing description, it will be evident to a person skilled in the art that various modification may be made within the scope of the invention, as defined in the claims.

All aspects as described in the following with respect to the composite also hold for the composite obtainable by the specific process, for the process for providing the composite and the switchgear as far as appropriate.

The wording “composite including hafnium carbide (HfC) and/or zirconium carbide (ZrC), the composite having” is to be understood to mean “composite including hafnium carbide (HfC) and/or zirconium carbide (ZrC), the composite consisting of”. The wording “providing hafnium carbide powder (HfC) and/or zirconium carbide powder (ZrC)” also encompasses the provision of such mixture by using a blend powder. The term “total carbide content being the sum of tungsten containing carbides, hafnium carbide, zirconium carbide, tantalum carbide and chromium carbide” indicates the total weight amount of tungsten containing carbides, hafnium carbide, zirconium carbide, tantalum carbide and chromium carbide. This means, the weight amounts of components such as WC, W2C, WTiC, HfC, ZrC, TaC, Cr2C3 need to be added together. The terms amount and content are used synonymously. If not mentioned otherwise, percentages are given with respect to the composite.

The incorporation of hafnium carbide and/or zirconium carbide turned out to be surprisingly beneficial as to the properties useful for various application such as in contact tips. Oxide layers formed on HfC grains result in the breakdown of the grains into many smaller grains on cooling. This exposes a fresh, oxide free surface with minimal change in contact resistance for the subsequent operations.

Without being bound by theory, it is believed that the higher melting point (2758° C.) and boiling point (5400° C.) of hafnium oxide (HfO2) vis-à-vis tungsten oxide (WO3, Tm=1473° C.; Tb=1700° C.) significantly reduces the material loss and/or the compositional changes of the contact material due to evaporation under arcing. Surprisingly, unlike silver tungstate (Ag2WO4) silver-hafnium combined oxides do not appear to form.

The better arc erosion resistance offers structural stability for contact materials that further paves the way to reduce the overall size of the contacts leading to cost savings.

Preferably the total carbide content being the sum of tungsten containing carbides, hafnium carbide, zirconium carbide, tantalum carbide and chromium carbide is within the range of 33.0 wt.-% to 60.0 wt.-%, more preferably 36.0 to 55.0 wt.-% and most preferably 38.0 to 45.0 wt.-%, all weight percentages with respect to the total weight of the composite.

The composite as described herein preferably has a conductivity (% IACS at 20° C.) of at least 30.0%, more preferably 35.0% and most preferable at least 40.0%. Electrical conductivity is mainly influenced by the total Ag content, whereby a high Ag (content going hand in hand with a lower carbide content) increases electrical conductivity.

In a first embodiment, the composite as described herein preferably has a density of more than 96.0%, more preferably more than 97.0% and most preferably more than 98.0% of the theoretical density.

In a second and even more preferred embodiment, the composite as described herein preferably has a density of more than 98.0%, more preferably more than 98.5% and most preferably more than 99.0% of the theoretical density. It was surprisingly found that densities of higher than 90.0% of the theoretical density can be achieved upon sintering without repressing or hot isostatic pressing for HfC contents up to 25.0 wt.-%. Repressing and/or hot isostatic pressing (HIP) allows even higher densities, particularly for values of higher than 98.0% of the theoretical density.

In a preferred aspect, the composite as described herein includes the metal component selected from the group of elements consisting of Ni, Co, Cu, Fc, Cr, Mo and mixtures thereof in an amount of up to 2.0 wt.-% with respect to the total weight of the composite. It is further preferred that the metal component is present in an amount of 0.5 to 1.5 wt.-%. Independent therefrom, it is preferred that the metal component is nickel (Ni).

It is also possible to include nickel (Ni), also denoted “further nickel herein” in higher amounts of up to 18.0 wt.-% as yet a further component. If so, the maximum total amount of nickel is 22.0 wt.-% being the sum of the metal component (being nickel) and the maximum amount of the “further nickel”. Usually the maximum total amount of nickel will be 20.0 wt.-% being the sum of the metal component (being nickel) and the maximum amount of the “further nickel”.

In a preferred embodiment the total amount of nickel in the composite ranges from 4.0 to 20.0 wt.-%, preferably from 6.0 to 14.0 wt. % and most preferably from 7.0 to 12.0 wt.-%.

In yet a further preferred aspect, the composite as descried herein includes tungsten carbide (WC) in an amount of at least 32.0 wt.-%, more preferably at least 34 wt.-% and most preferably at least 36 wt.-% with respect to the total weight of the composite. Preferably the composite as descried herein includes tungsten carbide (WC) in an amount of less than 50.0 wt.-%, more preferably at least 45.0 wt.-% and most preferably at least 43.0 wt.-% with respect to the total weight of the composite.

It is also preferred that the composite as described herein has one or more of the following characteristics: Vickers hardness (HV1) of more than 128.0, preferably more than 135.0, most preferably more than 140.0; Electrical conductivity (% IACS at 20° C.) of at least 35.0%, preferably at least 45.0% and most preferably at least 46.0%.

A Vickers hardness (HV1) of more than 135.0 can be easily achieved by increasing the total carbide amount to at least 40.0 wt.-%. Higher total carbide amounts will further increase Vickers hardness (HV1). Electrical conductivity is also mainly influenced by the amount of total carbides: a lower amount increases electrical conductivity. A value of 45.0% may be achieved by a total carbide amount of 40.0 wt.-% or lower. Further improvements as to the electrical conductivity can be made by increasing the sintering temperature when producing the composite or by repressing, both of which will contributes towards a higher final density.

A good balance of Vickers hardness (HV1) and electrical conductivity (% IACS at 20° C.) can be achieved when the total carbide amount is in the range of 38.0 to 45.0 wt.-%. The balance of Vickers hardness (HV1) and electrical conductivity (% IACS at 20° C.) is further improved when the composite is sintered at rather high temperatures, particularly from 1100 to 1250° C.

In a preferred aspect, the present invention provides a composite obtainable by providing aa) hafnium carbide powder (HfC) and/or zirconium carbide powder (ZrC), bb) silver powder (Ag), cc) optionally tungsten carbide powder (WC), dd) optionally a metal component selected from the group of elements consisting of Ni, Co, Cu, Fe, Cr, Mo and mixtures thereof in powder form, cc) optionally nickel, or further nickel mixing all powders as provided in step a) thereby yielding a premix, optionally sieving the premix and obtaining a sieved premix, compacting the premix or the sieved premix to form a green body, subjecting the green body to sintering, whereby the sintering is liquid phase sintering (LPS) within a temperature range of 960 to 1300° C., preferably 960 to 1150° C. under hydrogen atmosphere, optionally subjecting the sintered premix or sintered sieved premix to repressing and/or hot isotactic pressing (HIP).

The composites obtained in such a way are characterized by a unique combination of high theoretical density, excellent hardness and acceptable conductivity. All preferred aspects as described herein with respect to the composite shall also hold for composite obtainable by the above process.

The present invention further provides a process for providing the composite including hafnium carbide (HfC) and/or zirconium carbide (ZrC) as described herein. This process is particularly suitable for medium to full scale preparation of the composite. In this process, a combined sintering and silver infiltration of the green body takes place. Such combined sintering and silver infiltration process is as such known in the art and usually denoted liquid phase sintering plus silver infiltration. The temperature for liquid phase sintering plus silver infiltration will usually be in the range of 960° C. to 1200° C., preferably 960 to 1150° C. A temperature significantly above 1200° C. is undesirable as cracking of the composite with internal agglomerations of silver can occur. Moreover, when the temperature of significantly above 1200° C. and a low pressure such as below 100 mbar is applied, volatilization and loss of silver occurs. All aspects as described above with respect to the composite shall also hold for the process.

The composites as described herein are specifically useful for switchgear. The present invention therefore provides switchgear comprising the composite as described herein. Moreover, the present invention concerns the use of the composites as described herein for switchgear, particularly low voltage switchgear.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A composite including hafnium carbide (HfC) and/or zirconium carbide (ZrC), the composite having:
a) a total carbide content being the sum of tungsten containing carbides, hafnium carbide, zirconium carbide, tantalum carbide and chromium carbide of more than 30 wt.-% with respect to the total weight of the composite, and
b) a combined amount of hafnium carbide and/or zirconium carbide of 0.1 wt.-% to 40 wt.-% with respect to the total carbide content, and
c) up to 4.0 wt.-% of a metal component with respect to the total weight of the composite, and
d) up to 18.0 wt.-% of nickel or further nickel with respect to the total weight of the composite, and
e) the balance being silver (Ag) and unavoidable impurities.

2. The composite according to claim 1, wherein the composite has a conductivity (% IACS at 20° C.) of at least 30.0%.

3. The composite according to claim 1, wherein the composite has a density of more than 96.0% of the theoretical density.

4. The composite according to claim 1, wherein the metal component is selected from the group of elements consisting of Ni, Co, Cu, Fe, Cr, Mo and mixtures thereof.

5. The composite according to claim 4, wherein the metal component is nickel (Ni).

6. The composite according to claim 1, wherein the total amount of nickel is:
i) up to 2.0 wt.-% with respect to the total weight of the composite,
or
ii) from 4.0 to 20.0 wt.-%, with respect to the total weight of the composite.

7. The composite according to claim 1, wherein the total carbide content is within a range of 33.0 wt.-% to 60.0 wt.-% with respect to the total weight of the composite.

8. The composite according to claim 1, wherein tungsten carbide (WC) is present in an amount of at least 32.0 wt.-%.

9. The composite according to claim 1, wherein the composite has:
i) a Vickers hardness (HV1) of more than 128; and/or
ii) an Electrical conductivity (% IACS at 20° C.) of at least 35.0%.

10. The composite according to claim 1, wherein the composite has a total carbide content being a sum of tungsten containing carbides, hafnium carbide, zirconium carbide, tantalum carbide and chromium carbide of 38.0 to 45.0 wt.-% with respect to the total weight of the composite.

11. The composite according to claim 1, obtainable by:
a) providing
aa) hafnium carbide powder (HfC) and/or zirconium carbide powder (ZrC),
bb) silver powder (Ag),
cc) tungsten carbide powder (WC),
dd) a metal component selected from the group of elements consisting of Ni, Co, Cu, Fe, Cr, Mo and mixtures thereof in powder form, and
ee) nickel or further nickel,
b) mixing all powders thereby yielding a premix,
c) sieving the premix,
d) compacting the premix to form a green body
e) subjecting the green body to sintering, whereby the sintering is liquid phase sintering (LPS) within a temperature range of 960 to 1300° C. under hydrogen atmosphere; and
f) subjecting the sintered premix to repressing and/or hot isotactic pressing (HIP).

12. A process for providing a composite including hafnium carbide (HfC) and/or zirconium carbide (ZrC) having:
a) a total carbide content being a sum of tungsten containing carbides, hafnium carbide, zirconium carbide, tantalum carbide and chromium carbide of more than 30 wt.-% with respect to a total weight of the composite, and
b) a combined amount of hafnium carbide and/or zirconium carbide of 0.1 wt.-% to 40 wt.-% with respect to the total carbide content, and
c) up to 4.0 wt.-% of a metal component selected from the group of elements consisting of Ni, Co, Cu, Fe, Cr, Mo and mixtures thereof with respect to the total weight of the composite, and
d) up to 18.0 wt.-% of nickel or further nickel with respect to the total weight of the composite, with the balance being silver (Ag) and unavoidable impurities,
the process comprising the steps of
i) providing hafnium carbide powder (HfC) and/or zirconium carbide powder (ZrC), optionally silver powder (Ag), optionally tungsten carbide powder (WC), optionally a metal component selected from the group of elements consisting of Ni, Co, Cu, Fe, Cr, Mo and mixtures thereof in powder form,
ii) mixing all powders as provided in step i) thereby yielding a premix,
iii) sieving the premix and obtaining a sieved premix,
iv) compacting the sieved premix to form a green body,
v) combined sintering and silver infiltrating the green body within a temperature range of 960 to 1200° C., preferably 960 to 1150° C., and
vi) repressing and/or hot isotactic pressing (HIP).
